(19) United States
(12) Patent Application Publication
(10) Pub. No.: US 2015/0189930 A1
(43) Pub. Date: Jul. 9, 2015

(54) GLOVE AND STAND

(71) Applicants: Tomer A. Roth, Los Angeles, CA (US); Yael M. Roth, Los Angeles, CA (US)

(72) Inventors: Tomer A. Roth, Los Angeles, CA (US); Yael M. Roth, Los Angeles, CA (US)

(21) Appl. No.: 14/588,782

(22) Filed: Jan. 2, 2015

Related U.S. Application Data
(60) Provisional application No. 61/924,470, filed on Jan. 7, 2014.

(51) Int. Cl. A41D 19/00; F16M 13/02; A47B 61/00; A41D 19/015

(52) U.S. Cl. CPC A41D 19/0024; A41D 19/015; F16M 13/02; A47B 61/003

(57) ABSTRACT

A reusable glove a thumb portion and one or more finger portions, and a wide main proximal end wall portion having a lip that extends around the circumference of the wide main proximal end wall portion. A stand includes a base, a rim, and one or more support members connected between the rim and the base, and the lip of the wide main proximal end wall portion is configured to engage and rest upon the rim of a stand to position the wide main proximal end wall portion upward for ease of insertion of a user's hand. An index finger portion and the thumb portion may include conductive material to allow user to operate a touch screen device.

### CROSS-REFERENCES TO RELATED APPLICATIONS

This application is based upon and claims priority from U.S. Application No. 61/924,470, filed Jan. 7, 2014, which is incorporated by reference in its entirety.

### BACKGROUND

The present invention relates generally to protective gloves and mitts, and more particularly relates to a reusable sanitary barrier glove for use in a kitchen or other work environment where a user's hands typically become soiled or otherwise contaminated, allowing a user with contaminated hands to touch and manipulate objects without contaminating the objects, and a stand for the glove allowing a user to slip the glove on and off as desired.

Heat resistant oven mitts and pot holders are known for use in a kitchen for protecting hands of a user while handling heated pots and pans. For example, one such conventional protective glove for housework or use in a kitchen is known that is made of a heat resistant silicone material and includes main pocket for four fingers of a user, and a secondary pocket for the thumb of the user. The glove includes ribs inside or outside surfaces for better gripping with the glove. However, once a user's hands become greasy, or otherwise heavily soiled or contaminated, putting such a glove or mitt on typically involves touching the outside surface of the glove or mitt, allowing the possible contamination of the outside surface of the glove or mitt, so that in order for a user to use such a glove or mitt, the user's hands need to be cleaned or covered with another intermediate protective glove, which can be inconvenient if clean or sterile objects need to be handled repeatedly in the work area.

For example, handling and cutting raw meat in a kitchen with ungloved, unprotected hands can risk contamination of a user's hands with potentially pathogenic bacteria, so that manipulating objects in the kitchen, such as a stove, faucet or telephone, can risk contamination of the objects with pathogenic bacteria unless the user's hands are washed first, and this process would need to be repeated any time such objects would need to be handled.

One conventional type of elastomeric glove is known that includes a raised loop attached to the wrist portion of the glove to facilitate removal of the glove without physically contacting the external surface of the glove. Another type of retractable clean room or glove box glove for use in handling objects in isolation is known that includes a series of longitudinal elastic strips located in the sleeve of the glove to allow the glove to be moved to a retracted position close to a chamber wall. Another type of insulated mitt for protecting a user's hands during food preparation is known that includes pockets for an elongated rigid utensil on the palm and back of the mitt to assist with various cooking tasks. Another type of two-sided pocketed hand shield for protecting a user's hand from germs is known that includes a sheet of flexible material and a piece of flexible material attached to a front surface of the sheet of flexible material to form a pocket for a user's hand. However, such gloves or mitts typically include a main trank portion connected between a main opening and thumb and finger sections of the gloves or mitts, and forming most of the mid-portion of the gloves or mitts, with the gloves or mitts typically extending from a user's fingertips to well beyond a base of the user's thumb and along at least a portion of a user's forearm, which can substantially interfere with insertion of a user's hand into such a glove or mitt as well as removal of such a glove or mitt from the user's hand, particularly when the user's hand is greasy, or otherwise heavily soiled or contaminated.

It would be desirable to provide a reusable glove or mitt, such as a rubber or silicone rubber glove, mitt or half-mitten, for example, without a main trank portion between a base of the glove, mitt or half-mitten and openings to thumb and finger sections, and that can sit in a stand ready for use, so that a user with contaminated hands can readily insert a hand into the glove or mitt and pull the glove or mitt out of the stand for handling objects without contaminating them. It would also be desirable to provide such a reusable glove or mitt that includes a wide main proximal end wall portion having an outer rib or lip that together serve to catch and redirect contaminating material from a user's hand, wrist or forearm, into the inside of the glove or mitt rather than allowing such contaminating material to soil the exterior of the glove or mitt. It would also be desirable to provide such a reusable glove or mitt that can be replaced in the stand after use by slipping the glove or mitt off of a user's hand onto the stand, so that the user can resume non-sterile activities. It would also be desirable to provide such a reusable glove or mitt that can be cleaned either in a normal configuration ready for reuse or turned inside out in a dishwasher. The present invention meets these and other needs.

### SUMMARY OF THE INVENTION

Briefly and in general terms, the present invention provides for a reusable glove, mitt or half-mitt, without a main trank portion between a base and openings to thumb and finger sections, that can be placed in a stand, such as on a table top or a kitchen countertop, for example, ready for use, so that a user with contaminated hands can readily insert a hand into the glove or mitt and pull the glove or mitt out of the stand for handling objects without contaminating them, and that can be readily cleaned either in a normal use configuration or optionally turned inside out for cleaning.

Accordingly, the present invention provides for a reusable glove or mitt that includes a thumb section for a user's thumb, and one or more finger sections for a user's second through fifth fingers, and that is advantageously configured to cover a user's hand up to the user's wrist, and typically only to the base of the user's thumb, for example. The reusable glove or mitt includes a generally round, wide main proximal end wall portion for ease insertion of a user's thumb and fingers into the thumb section and the one or more finger sections, and a thin rib or lip, such as an L-shaped lip, for example, that preferably extends around the circumference of the wide main proximal end wall portion. This rib or lip is configured to engage a rim of a small countertop stand, to position the wide main proximal end wall portion of the reusable glove or mitt facing upwardly, ready for use. The wide main proximal end wall portion and outer rib or lip together serve to catch and redirect contaminating material from a user's hand, wrist or forearm, into the inside of the glove or mitt, to prevent such contaminating material to soil the exterior of the reusable glove or mitt. In a presently preferred aspect, the reusable glove or mitt is formed of a heat resistant material, such as a heat resistant rubber or silicone rubber, for example, having a thickness suitable for protecting a user's hands from heat. When a user's hands are contaminated and the user needs to handle other items in a sterile manner, the user can insert a hand into the reusable glove or mitt and pull the reusable glove or mitt away from the stand. When the inside of the reusable glove or mitt becomes contaminated, the exterior surface of the reusable glove or mitt remains sterile. Using this reusable glove or mitt, a user can manipulate objects in a work area, such as a kitchen, for example, without fear of contaminating the objects. The reusable glove or mitt can be easily slipped off of a user's hand and replaced in the stand at any time, and the user can resume non-sterile activities. After using the reusable glove or mitt in this manner, the user can clean the glove or mitt in the normal use configuration, or optionally invert or turn the reusable glove or mitt inside out for cleaning, such as in a dishwasher, for example.

In one presently preferred variation, the reusable glove or mitt includes a generally round, wide main proximal end wall portion, a thumb section connected to the wide main proximal end wall portion for receiving a thumb of the user's hand, a first smaller additional index finger section connected to the wide main proximal end wall portion for receiving a second or index finger of the user's hand, and a second smaller additional finger section connected to the wide main proximal end wall portion for receiving a third finger, a fourth finger and a fifth finger of the user's hand. In a presently preferred aspect, the index finger section includes an index finger tip portion optionally includes an outer surface including a conductive material, such as graphite powder or a conductive thread, for example, configured for operation of a touch screen device. In another presently preferred variation, the thumb section also optionally includes thumb tip portion having an outer surface including such a conductive material. In another presently preferred aspect, the additional finger section for receiving the third, fourth and a fifth fingers of the user's hand is curved.

In another presently preferred aspect, the reusable glove or mitt is dimensioned to extend a length from a user's fingertips to a base of the user's thumb, but not beyond the base of the user's thumb toward the user's wrist, to facilitate insertion of the user's hand into the reusable glove or mitt as well as removal of the reusable glove or mitt. In another presently preferred aspect, the wide main proximal end wall portion of the reusable glove or mitt includes a rib or lip extending outwardly from the wide main proximal end wall portion of the reusable glove or mitt, such as a thin L-shaped rib or lip, for example. The rib or lip is configured to engage a rim of a small countertop stand, positioning the wide main proximal end wall portion of the reusable glove or mitt facing upwardly, for ease of insertion of a user's hand.

In another presently preferred aspect, the stand includes a base configured to rest on a table or countertop, a rim portion having a shape corresponding to the shape of the outer circumference of the wide main proximal end wall portion. The rim portion is configured receive the thumb and finger portions of one or more reusable gloves or mitts when inserted through the rim portion, and is configured to support the rib or lip of the reusable glove or mitt, preferably spaced apart from the base, for example, by one or more support members, such as posts, columns, pedestals or walls connected between the rim portion and the base. In one presently preferred variation, the one or more support members can form an enclosure around the base and up to the rim portion of the stand. In another presently preferred aspect, the rim portion is a ring, although rim portion may alternatively include discrete sections configured to support portions of the rib or lip of the reusable glove or mitt when the thumb and finger portions of the reusable glove or mitt are inserted through the rim portion. In a presently preferred aspect, the rim portion is formed as a round ring.

These and other features and advantages of the present invention will become apparent from the following detailed description of preferred embodiments which, taken in conjunction with the accompanying drawings, illustrate by way of example the principles of the invention.

### BRIEF DESCRIPTION OF THE DRAWINGS

FIG. 1 is a perspective view of a first embodiment of a stand for use with the reusable glove or mitt according to the present invention.

FIG. 2 is a perspective view of a first embodiment of a reusable glove or mitt according to the invention, placed in the stand of FIG. 1.

FIG. 3 is a perspective view of the reusable glove or mitt of FIG. 2.

FIG. 4 is a front side elevational view of the reusable glove or mitt of FIG. 2, illustrating insertion of a user's thumb and fingers into the reusable glove or mitt.

FIG. 5 is a rear side elevational view of the reusable glove or mitt of FIG. 2.

FIG. 6 is a top plan view of the reusable glove or mitt of FIG. 2.

FIG. 7 is a side elevational view of the reusable glove or mitt of FIG. 2.

FIG. 8 is a front side elevational view of a second embodiment of a reusable glove or mitt according to the invention.

FIG. 9 is a rear side elevational view of the reusable glove or mitt of FIG. 8.

FIG. 10 is a top plan view of the reusable glove or mitt of FIG. 8.

FIG. 11 is a side elevational view of the reusable glove or mitt of FIG. 8.

FIG. 12 is a perspective view illustrating use of the reusable glove or mitt of FIG. 8 with a touch screen device.

FIG. 13 is a perspective view of a variation of the stand for use with the reusable glove or mitt according to the present invention, showing the stand with a wall mountable base, that can be hung or fixedly attached to a vertical wall, with the columns of the stand extending upwardly from the base.

FIG. 14 is a perspective view of a second embodiment of a stand for use with the reusable glove or mitt according to the present invention.

FIG. 15 is a top plan view of the stand of FIG. 14.

FIG. 16 is a side elevational view of the stand of FIG. 14.

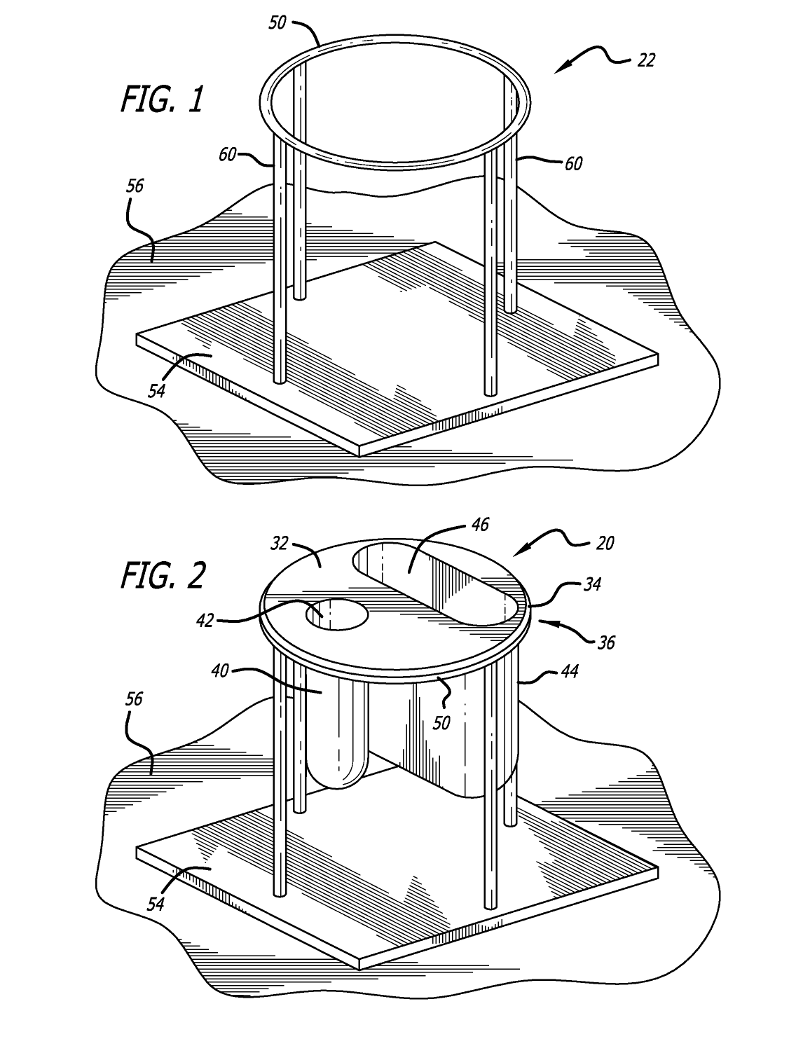

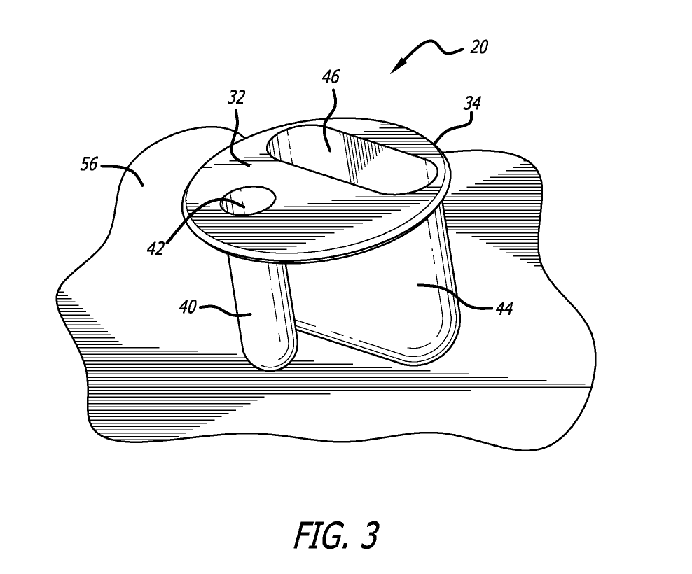

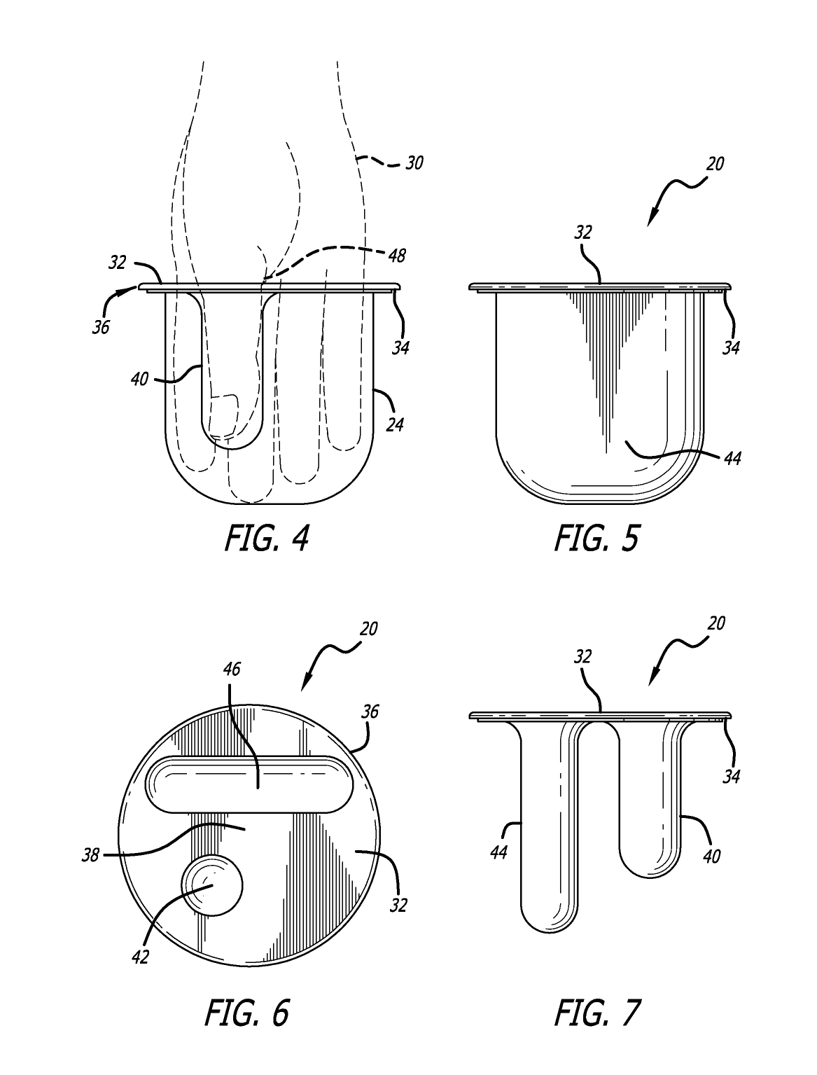

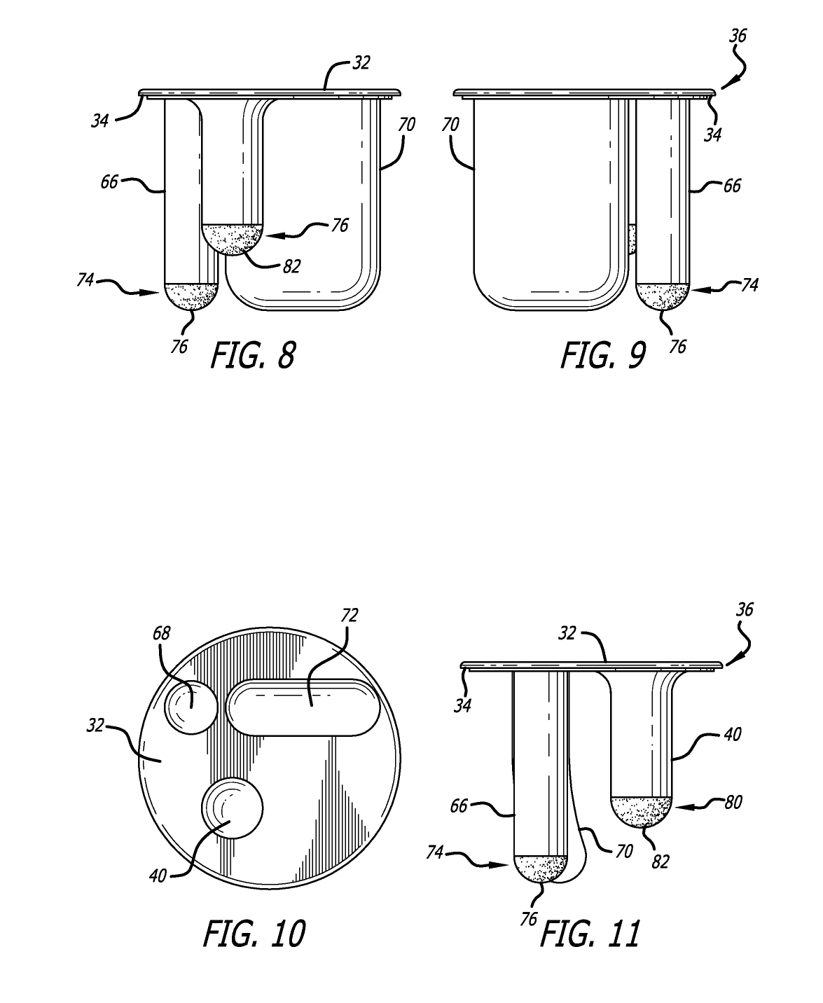

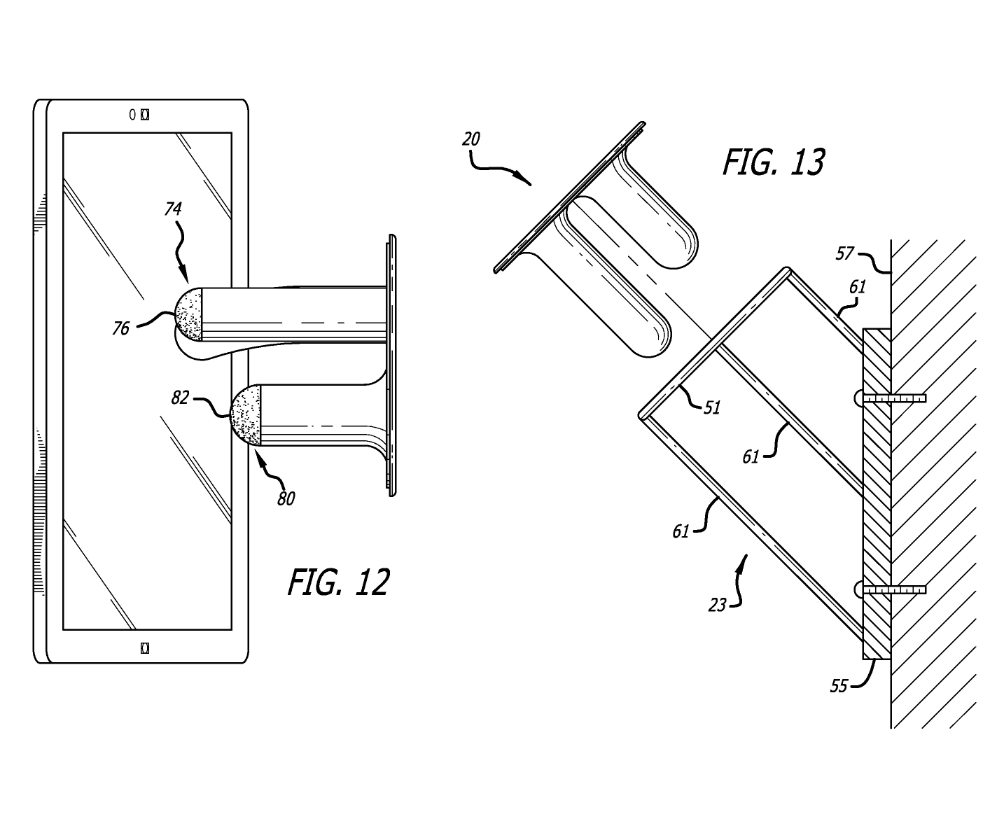

### DETAILED DESCRIPTION OF THE PREFERRED EMBODIMENTS

As is illustrated in the drawings, which are provided for the purposes of illustration and not by way of limitation, the present invention provides for a reusable glove or mitt 20 that can be placed in a stand 22, such as on a table top or a kitchen countertop, for example. The reusable glove or mitt has an exterior surface 24, and other interior spaces described below.

The reusable glove or mitt includes a generally round, wide main proximal end wall portion 32 connected to the thumb and finger sections providing the interior spaces for the thumb and fingers, for ease of insertion of the user's hand in the reusable glove or mitt. The wide main proximal end wall portion includes an outer thin rib or lip 34, such as an L-shaped lip, for example, that extends around the circumference 36 of the wide main proximal end wall portion. The reusable glove or mitt includes a thumb section 40 having an interior thumb space 42 connected to the wide main proximal end wall portion for receiving a thumb of the user's hand, and one or more finger sections 44 connected to the wide main proximal end wall portion and having a corresponding interior finger space 46 for receiving the second through fifth fingers of the user's hand. In one presently preferred aspect, the reusable glove or mitt is dimensioned to extend a length from a user's fingertips to a base of the user's thumb 48, but preferably not beyond the base of the user's thumb toward the user's wrist, to facilitate insertion of the user's hand into the reusable glove or mitt as well as removal of the reusable glove or mitt.

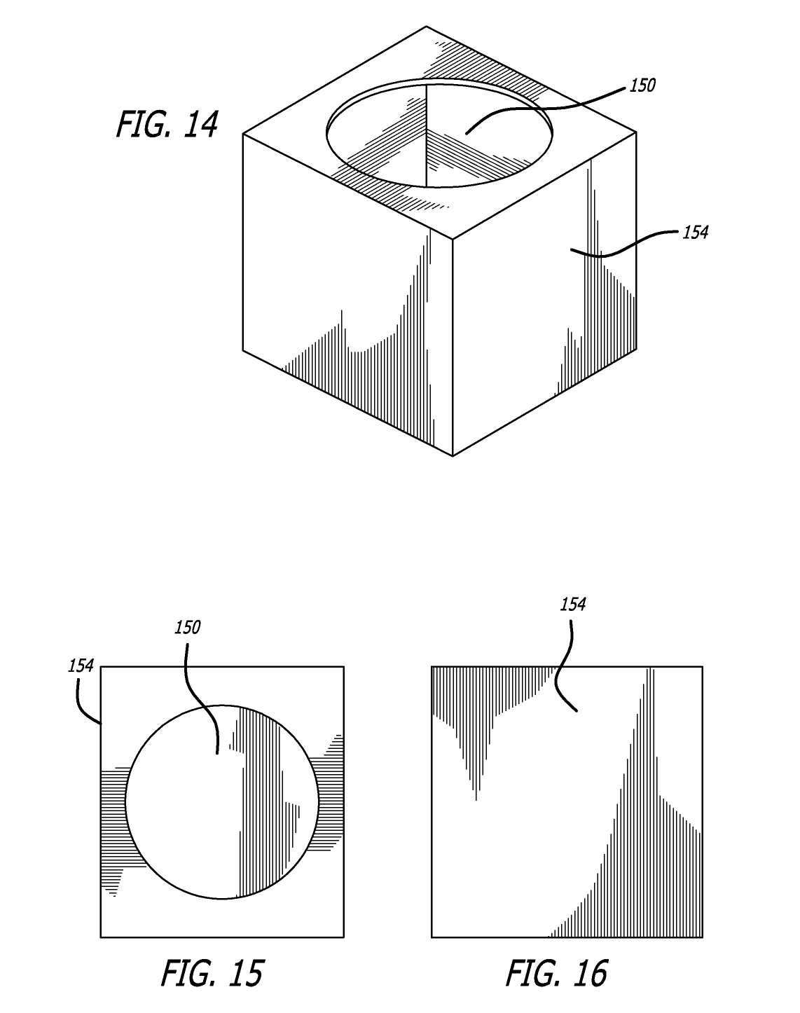

The rib or lip around the circumference of the wide main proximal end wall portion is configured to engage a rim portion 50 of the small stand configured to position the wide main proximal end wall portion of the reusable glove or mitt facing upwardly, for ease of insertion of a user's hand. The rib or lip and generally round, wide main proximal end wall portion together serve also serve to catch and redirect grease, liquids or debris or similar contaminating material that may tend to drip from a user's hand, wrist or forearm, into the inside of the glove, rather than allowing such contaminating material to soil the exterior of the glove. The stand includes a base 54 configured to rest on a substrate 56 such as a table or countertop, for example. The rim portion is preferably configured receive the thumb and finger portions of the reusable glove or mitt and to support the rib or lip of the reusable glove or mitt, typically spaced apart from the base, for example, by one or more support members, such as posts, columns, pedestals or walls 60 connected between the rim portion and the base. In one presently preferred variation illustrated in FIGS. 14-16, the one or more support members can form sides 154 forming an enclosure around the base and up to the rim portion forming an upper opening 150 of the stand, so that the stand is completely enclosed to ensure that the outer surface of the one or more reusable gloves or mitts enclosed by the stand are only exposed once following removal from the stand, to facilitate use of the reusable gloves or mitts in a dirty work area, such as where someone is painting, for example, by protecting the outside of the glove from being splattered with dirt, paint or other contamination. In another presently preferred variation, a plurality of reusable gloves or mitts can be stacked in a nested configuration on the rim or upper opening of the stand. In another presently preferred aspect, the rim portion is a ring, although the rim portion may alternatively include discrete sections configured to support portions of the rib or lip of the reusable glove or mitt when the thumb and finger portions of the reusable glove or mitt are inserted through the rim portion.

In another presently preferred aspect, at least a major portion of the reusable glove or mitt is formed of at least one main layer of a heat resistant material, such as a heat resistant rubber or silicone rubber, for example, having a thickness suitable for protecting a user's hands from heat. Optionally, the one or more main layers of heat resistant material may be sufficiently thin to provide somewhat reduced protection from heat while allowing a plurality of the reusable glove or mitt to be stacked in a stand, ready for use. Selected portions of the reusable glove or mitt may also include additional layers of flexible material, as will be further described below.

In another presently preferred embodiment, the reusable glove or mitt includes a wide main proximal end wall portion, a thumb section for receiving a thumb of the user's hand, a first smaller additional index finger section 66 connected to the wide main proximal end wall portion and having a corresponding interior index finger space 68 for receiving a second or index finger of the user's hand, and a second smaller additional finger section 70 connected to the wide main proximal end wall portion and having a corresponding interior finger space 72 for receiving a third finger, a fourth finger and a fifth finger of the user's hand. In one presently preferred aspect, the additional finger section for receiving the third, fourth and a fifth fingers of the user's hand may be curved. The index finger section optionally includes an index finger tip portion 74 having an outer surface 76, such as an additional outer layer of flexible material adhered to an outer surface of the main layer of heat resistant material, and including a conductive material, such as graphite powder or a conductive thread, for example, configured for operation of a touch screen device. Alternatively, the outer surface of the main layer of heat resistant material at the index finger tip portion of the index finger section may be formed to include such a conductive material.

In another presently preferred aspect, the thumb section optionally may also include a thumb tip portion 80 having an outer surface 82, such as an additional outer layer of flexible material adhered to an outer surface of the main layer of heat resistant material, and including a conductive material, such as graphite powder or a conductive thread, for example, configured for operation of a touch screen device. Alternatively, the outer surface of the main layer of heat resistant material at the thumb tip portion of the thumb section may be formed to include such a conductive material.

When a user's hands are contaminated and the user needs to handle other items in a sterile manner, the user can insert a hand into the reusable glove or mitt and pull the reusable glove or mitt away from the stand. When the inside of the reusable glove or mitt becomes contaminated, the exterior surface of the reusable glove or mitt remains sterile. Using this reusable glove or mitt, a user can manipulate objects in a work area, such as a kitchen, for example, without fear of contaminating of the objects. The reusable glove or mitt can be easily slipped off of a user's hand and replaced in the stand at any time, and the user can resume non-sterile activities. After using the reusable glove or mitt in this manner, the user can clean the glove or mitt in the normal use configuration, or optionally invert or turn the reusable glove or mitt inside out for cleaning, such as in a dishwasher, for example.

Alternatively, the heat resistant material used to form the glove or mitt can be made to be sufficiently thin that the glove or mitt to allow a plurality of gloves to be stacked on top of one another, such as on the stand, ready for use, and to allow the glove or mitt to be disposable, if desired. As is illustrated in FIG. 13, the stand 23 may also include a wall mountable base 55, that can be hung or fixedly attached to a vertical wall 57, with the one or more support members 61, such as posts, columns, pedestals or walls, extending from the base upwardly at an angle of about 30 to 80 degrees from a horizontal direction, or more preferably extending upwardly at an angle of about a 45 degree angle from the vertical wall, for example, with the rim 51 correspondingly approximately perpendicular to the one or more support members and angled correspondingly about 10 to 60 degrees away from the vertical wall, to allow one or more reusable gloves or mitts to be placed on the stand accessible by a user at a corresponding angle more from the side than from directly above the one or more reusable gloves or mitts.

It will be apparent from the foregoing that while particular forms of the invention have been illustrated and described, various modifications can be made without departing from the spirit and scope of the invention.

We claim:

1. A reusable glove for a portion of a user's hand, comprising:
a main proximal end wall portion including an outer thin rib that extends around a circumference of the main proximal end wall portion;
a thumb section connected to the main proximal end wall portion, said thumb section having a thumb section opening in said main proximal end wall portion and an interior thumb space configured to receive at least a portion of a thumb of the user's hand; and
at least one finger section connected to the main proximal end wall portion, said at least one finger section having a finger section opening in said main proximal end wall portion and a corresponding interior finger space configured to receive at least a portion of the user's second through fifth fingers.

2. The reusable glove of claim 1, wherein said thumb section includes a thumb tip portion having an outer surface including a conductive material such that said thumb tip portion is configured for operation of a touch screen device.

3. The reusable glove of claim 1, wherein said thumb section comprises a thumb tip portion including a main layer of heat resistant material and an outer layer of flexible material adhered to an outer surface of said main layer of heat resistant material.

4. The reusable glove of claim 3, wherein said outer layer of flexible material comprises a conductive material such that said thumb tip portion is configured for operation of a touch screen device.

5. The reusable glove of claim 1, wherein said at least one finger section comprises an index finger section connected to the main proximal end wall portion, said index finger section including a corresponding interior index finger space configured to receive an index finger of the user's hand, and a second finger section connected to the wide main proximal end wall portion, said second finger section having a corresponding interior finger space for receiving a third, fourth and fifth fingers of the user's hand.

6. The reusable glove of claim 5, wherein said index finger section includes an index finger tip portion having an outer surface and including a conductive material such that said index finger section is configured for operation of a touch screen device.

7. The reusable glove of claim 1, wherein said at least one finger section comprises a main layer of heat resistant material and an outer layer of flexible material adhered to an outer surface of said main layer of heat resistant material.

8. The reusable glove of claim 7, wherein said outer layer of flexible material comprises a conductive material such that said at least one finger section is configured for operation of a touch screen device.

9. The reusable glove of claim 1, wherein at least a major portion of the reusable glove is formed of at least one main layer of a heat resistant material.

10. A stand for a reusable glove including a thumb portion, a finger portion and a main proximal end wall portion including an outer thin rib extending around a circumference of the main proximal end wall portion, the stand comprising:
a base configured to rest on a substrate;
a rim portion configured to support at least one reusable glove stacked on said rim portion, said rim portion being configured receive a thumb portion and a finger portion of a reusable glove and to support an outer thin rib of a main proximal end wall portion of said at least one reusable glove; and
at least one support member connected between said base and said rim portion.

11. The stand of claim 10, wherein said at least one support member forms an enclosure around said base up to said rim portion.

12. The stand of claim 10, wherein said rim portion comprises a ring.

13. The stand of claim 10, wherein said rim portion comprises discrete sections.

14. The stand of claim 10, wherein said base comprises a wall mountable base configured to be attached to a vertical wall, and wherein said at least one support member is configured to extend upwardly from the base at an angle of about 30 to 80 degrees from a horizontal direction.

15. The stand of claim 10, wherein said at least one support member is configured to extend upwardly from the base at an angle of about 45 degrees from the vertical wall.

16. The stand of claim 10, wherein said at least one support member forms an enclosure around the base and up to said rim portion of said stand.

17. A combination of a stand and at least one reusable glove, comprising:
at least one reusable glove for a portion of a user's hand, said at least one reusable glove including a thumb portion, a finger portion and a main proximal end wall portion including an outer thin rib extending around a circumference of the main proximal end wall portion; and
a stand including a base configured to rest on a substrate, a rim portion configured to support said at least one reusable glove stacked on said rim portion, said rim portion being configured receive a thumb portion and a finger portion of a reusable glove and to support an outer thin rib of a main proximal end wall portion of said at least one reusable glove, and at least one support member connected between said base and said rim portion.

18. The combination of a stand and at least one reusable glove of claim 17, wherein said at least one reusable glove comprises a plurality of reusable gloves.

19. The combination of a stand and at least one reusable glove of claim 17, wherein said base comprises a wall mountable base configured to be attached to a vertical wall, and wherein said at least one support member is configured to extend upwardly from the base at an angle of about 30 to 80 degrees from a horizontal direction.

20. The stand of claim 19, wherein said at least one support member is configured to extend upwardly from the base at an angle of about 45 degrees from the vertical wall.
